(19) United States
(12) Patent Application Publication
(10) Pub. No.: US 2006/0256940 A1
(43) Pub. Date: Nov. 16, 2006

(54) Inmate voice mail system and method

(75) Inventors: Joseph Henry Pekarovic, Los Angeles, CA (US); Richard Brent Siebels, North Hills, CA (US)

Correspondence Address: KEUSEY, TUTUNJIAN & BITETTO, P.C., 20 CROSSWAYS PARK NORTH, SUITE 210, WOODBURY, NY, 11797, US

(73) Assignee: PUBLIC COMMUNICATIONS SERVICES, INC

(21) Appl. No.: 11/126,726

(22) Filed: May 11, 2005

(51) Int. Cl. H04M 1/64

(52) U.S. Cl. 379/88.26

(57) ABSTRACT

There are provided methods and systems for leaving voice mails for, and retrieving voice mails by, an inmate in a correctional facility. In a method for leaving a voice mail for an inmate in a correctional facility from an external caller outside the prison facility, identifying indicia is received for identifying the inmate from among a plurality of inmates. The identifying indicia is compared against a plurality of identifying indicia to determine whether a match exists there between. Each of the plurality of identifying indicia is for identifying one of the plurality of inmates. The external caller is permitted to leave the voice mail for the inmate, only when the match exists.

### FIELD OF THE INVENTION

The present invention generally relates to voice mail systems and, more particularly, to an inmate voice mail system and method.

### BACKGROUND OF THE INVENTION

Voice mail systems are becoming more prevalent in many applications and environments. One such application or environment in which a voice mail system is needed is a prison. However, given the restrictions placed upon inmates, a voice mail system used in a prison must take into account such restrictions as well as other conditions that are particular to a prison.

Accordingly, it would be desirable and highly advantageous to have a voice mail system for use in a prison that takes into account the various restrictions imposed on inmates as well as other conditions that are particular to a prison.

### SUMMARY OF THE INVENTION

These and other drawbacks and disadvantages of the prior art are addressed by the present invention, which is directed to an inmate voice mail system and method.

According to an aspect of the present invention, there is provided a method for leaving a voice mail for an inmate in a correctional facility from an external caller outside the prison facility. Identifying indicia is received for identifying the inmate from among a plurality of inmates. The identifying indicia is compared against a plurality of identifying indicia to determine whether a match exists there between. Each of the plurality of identifying indicia is for identifying one of the plurality of inmates. The external caller is permitted to leave the voice mail for the inmate, only when the match exists.

According to another aspect of the present invention, there is provided a method for retrieving a voice mail by an inmate in a correctional facility, the voice mail having been left by an external caller located outside the correctional facility. Verification indicia is received for verifying a claimed identity of the inmate. The verification indicia is compared against each of a plurality of verification indicia to determine whether a match exists there between. The inmate is permitted to retrieve the voice mail, only when the match exists.

According to yet another aspect of the present invention, there is provided a system for leaving a voice mail for an inmate in a correctional facility from an external caller outside the prison facility. The system includes means for receiving identifying indicia for identifying the inmate from among a plurality of inmates. The system further includes means for comparing the identifying indicia against a plurality of identifying indicia to determine whether a match exists there between. Each of the plurality of identifying indicia is for identifying one of the plurality of inmates. The system also includes means for permitting the external caller to leave the voice mail for the inmate, only when the match exists.

According to still another aspect of the present invention, there is provided a system for retrieving a voice mail by an inmate in a correctional facility, the voice mail having been left by an external caller located outside the correctional facility. The system includes means for receiving verification indicia for verifying a claimed identity of the inmate. The system further includes means for comparing the verification indicia against each of a plurality of verification indicia to determine whether a match exists there between. The system also includes means for permitting the inmate to retrieve the voice mail, only when the match exists.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 is a block diagram illustrating an inmate voice mail (IVM) system 100, according to an illustrative embodiment of the present invention;

FIG. 2 is a flow diagram illustrating a method 200 for leaving a voice mail on the inmate voice mail (IVM) system 100 of FIG. 1, according to an illustrative embodiment of the present invention; and

FIG. 3 is a flow diagram illustrating a method 300 for retrieving a voice mail from the inmate voice mail (IVM) system 100 of FIG. 1, according to an illustrative embodiment of the present invention.

### DETAILED DESCRIPTION

The present invention is directed to an inmate voice mail system and method. It is to be appreciated that the present invention may be implemented locally with respect to a particular correctional facility and/or may be centralized for use by more than one correctional facility.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

A description will now be given regarding some operational parameters for an inmate voice mail system in accordance with the present invention. It is to be appreciated that at least some of the following operational parameters may be illustrative and, thus, may be optional in some embodiments of the present invention.

An inmate voice mail system according to the present invention does not include directories and lookup tables that list inmates by name or other identifier and that are accessible by inmates or external callers. Rather, inmates are permitted to access the voice mail system by entering their mailbox identification number (also interchangeably referred to herein as “mailbox ID number” and “mailbox ID#”) and their Personal Identification Number (PIN). Moreover, external callers (callers calling into the prison) are permitted to access the voice mail system by entering the mailbox ID numbers of the inmates to which they desire to converse. The mailbox ID number of an inmate may be the same as the Master ID/Inmate Phone ID for that inmate. The PIN may be the same as the Inmate Phone System PIN.

A local database will be maintained of mailbox ID numbers and PINs. If an inmate is calling for the first time, then the present invention may provide an indication that a mailbox does not exist for that inmate and may continue by obtaining any information necessary to create a new mailbox for the inmate on the local database.

Inmates can only play and save Messages. Inmates do not have the ability to delete messages. Jail Administrators will have access to all mailboxes and files of recordings. The recordings may be stored/accessed in any pre-specified or dynamically selected form including, but not limited to MP3 files, wav files, and so forth. A prompt may be played informing inmates that their messages will be monitored.

Inmate can be limited in accessing their mailbox. For example, an inmate can be limited in accessing his/her mailbox only up to X times per Y period. In an illustrative embodiment of the present invention described herein, an inmate can only access the inmate voice mail system 2 times per day. Of course, other times and periods may also be employed while maintaining the spirit of the present invention.

If an inmate is disconnected while listening to a message, that message will remain as new, but the call will still count as one of his (2) calls for the day. A call is automatically disconnected if a maximum number of attempts has been exceeded. In such a case, a prompt may be played to the inmate to indicate the same.

The message length may be limited to a pre-specified and configurable time period (e.g., 10 seconds). Moreover, the number of messages stored per mailbox may-be limited to a maximum number (which may include new and/or saved messages).

Inmates do not have the ability to exit their mailbox and access another inmate's mailbox. Inmates do not have the ability to leave voicemail messages for other inmates. External callers do not have the ability to retrieve messages from an inmate's mailbox.

Ports designated for external callers should only include prompts for external callers, and ports designated for inmates should only include prompts for inmates. A speed dial function may be included and may be configured to point to the last (X out of Y) trunk ports and to work in a hunt group. The system may be configured to deal with “trouble tickets”, which are essentially messages left by an inmate (or an external caller) that describes a problem encountered during interaction with the system. For example, an inmate may leave a “trouble ticket” for a missing or inoperative password, which is received and processed by the system. In such a case, e.g., if warranted, a new password may be issued to the inmate by the system in response to the “trouble ticket”.

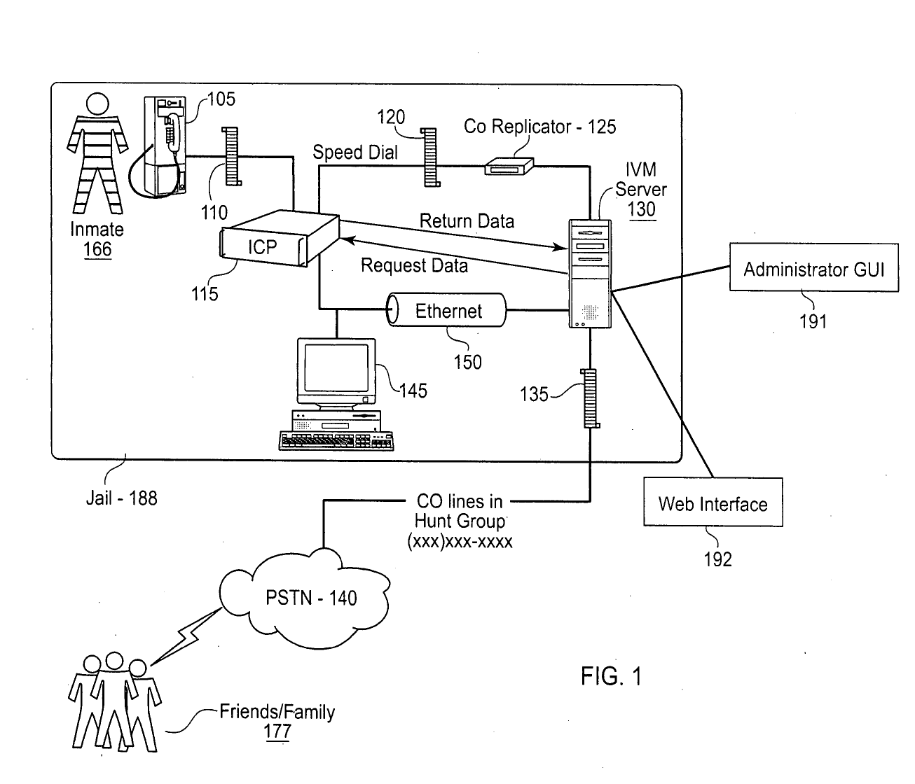

FIG. 1 is a block diagram illustrating an inmate voice mail (IVM) system 100, according to an illustrative embodiment of the present invention. The IVM system 100 is intended for use in connection with a correctional facility (also interchangeably referred to here as “jail” or “prison”) 188. The IVM system 100 allows friends, family, and others (also collectively referred to herein as “callers” or “external callers”) 177 to leave a voice mail for an inmate(s) 166, and for the inmate(s) 166 to retrieve the voice mails.

The system 100 includes at least one telephone 105 connected in signal communication with an inmate calling platform (ICP) 115 via an interconnection device 110. The ICP 115 is also connected in signal communication with a replicator 125 via an interconnection device 120, with an Ethernet based local area network or wide area network (network) 150, and with a workstation 145. An inmate voice mail (IVM) server 130 is connected in signal communication with a Public Switched Telephone Network (PSTN) 140 via an interconnection device 135, with the replicator 125, and with the network 150.

The at least one telephone 105 is for use by one or more inmates of a correctional facility.

The inter-connection devices 110, 120, and 135 represent the physical connection between, e.g., the at least one phone 105, telephone wiring, cabling, conduit, cross-connects, and so forth.

The ICP 115 is a completely automated telephone system (CATS) such as, but not limited to, an inmate phone system, private branch wxchange (PBX), or similar call switching equipment.

The IVM server 130 includes one or more memory devices (not shown) for storing voice mails thereon.

The IVM server 130 further includes an administrator GUI 191 and a web interface 192. The administrator GUI 191 allows an administrator or other authorized person to set configurable-settings corresponding to the IVM system 100. For example, the administrator GUI 191 allows an administrator or other authorized person to set the following parameters relating to the IVM system 100: maximum message length; maximum logins per day (or other time period); maximum active messages; mailbox ID length; system logging; and message storage path. It is to be appreciated that administrative control via the administrator GUI 191 is not limited to the preceding parameters and, thus, other parameters relating to the operation of the IVM system 100 may also be set/modified by the administrator GUI 191 while maintaining the scope of the present invention. The web interface 192 is for customer interaction with the system 100. The web interface 192 provides a means for employees and customers to access the system 100 through a secure login and by means of remote access. Functionality that is provided by the web interface 192 includes, but is not limited to, searching for inmate information, messages, system status, system parameters, calling party identification, add/edit users for access to the system, playback of recorded messages, administrative functions, and so forth.

The IVM server 130 also includes a logins table for storing the number of login attempts made in a single day for each of the inmates. Login attempts are recorded irrespective of whether or not they were successful. It is to be appreciated that other time periods may also be employed, while maintaining the scope of the present invention.

The ICP 115 includes a pin record table for storing mailbox identification numbers. Each inmate can be associated with a unique mailbox identification number.

The ICP 115 further includes a database of recordings/prompts that are played at appropriate times. The recordings/prompts are used, e.g., to inform an inmate or a caller who is calling an inmate of various options and/or to request information such as mailbox identification numbers and PINs.

The ICP 115 may be or include any type of Interactive Voice Response (IVR) system. Data requested from the ICP 115 by the IVM server 130 is routed through the Network 150, and data returned from the ICP 115 to the IVM server 130 in response to a request is routed through the network 150.

For a call made by an inmate to the IVM system 100, the call is originated on telephone 105, e.g., using a voice mail speed dial telephone number. The ICP 115 will identify the speed dial, select one of a plurality of designated trunks, and output a designated ANI to the replicator 125. The replicator 125 will provide a secure means for the IVM server 130 and the ICP 1 15 to communicate allowing the inmate to access his/her account without risk of the inmate accessing the PSTN 140. The replicator 125 provides dial tone and a simulated call path between the ICP 1 15 and the IVM server 130. In instances where a centralized model needs to be deployed, the replicator 125 can be replaced with other secure communications technologies including, but not limited to, OPX lines, dedicated circuits, VoIP, VPN and other standards based communication protocols.

For a call made to an inmate using the IVM system 100, the call is originated through the PSTN 140 by a public service subscriber from their home, office, cell or pay telephone. The end-user would dial a designated NANPA identified number that would be pre-registered. The IVM server 130 will have multiple inbound ports that will each be connected to a CO line, T1 circuit or VoIP solution in such a manner that the lines will roll-over (hunt) through the series of connected lines until an open port on the IVM server 130 is identified. The IVM server 130 will then answer the call and play a series of messages informing the end-user on how to leave a message. The IVM server 130 uses DTMF capture technologies that allow an end-user to interact with the IVM server 130 by pressing digits from the end-user telephone. In addition, the IVM server 130 can be configured to use speech recognition technologies to allow the end-user to speak commands to the IVM server 130.

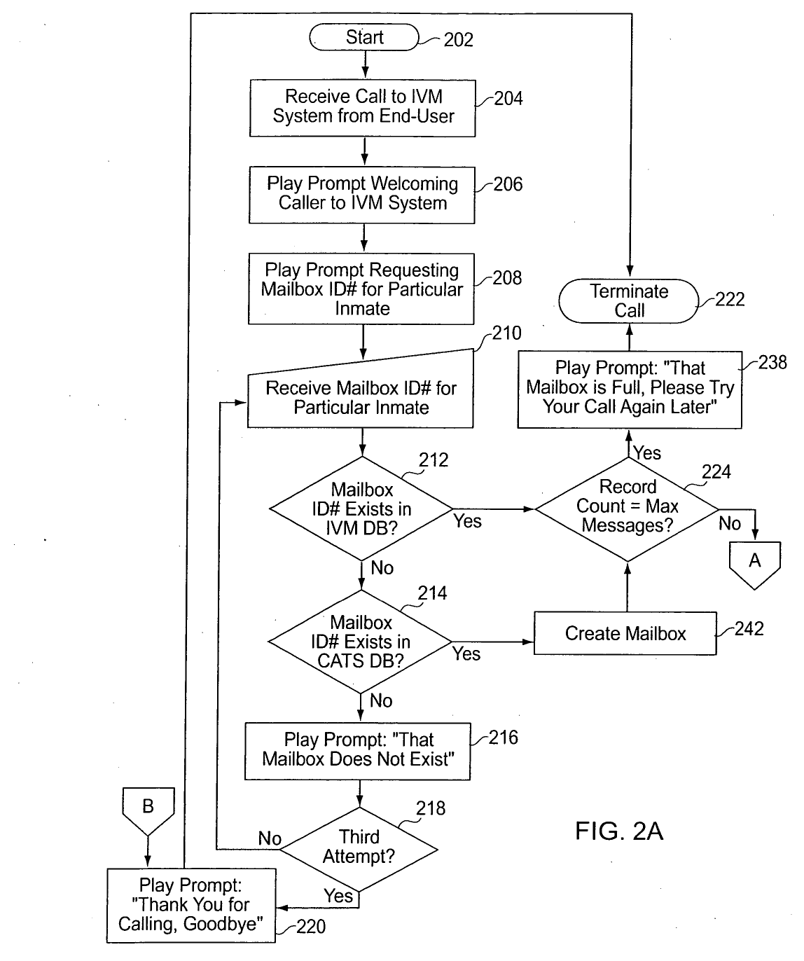

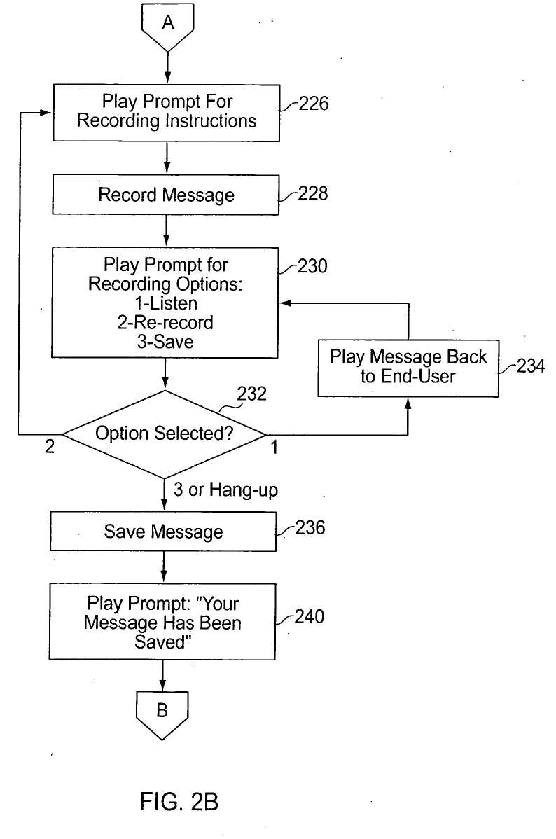

FIG. 2 is a flow diagram illustrating a method 200 for leaving a voice mail on the inmate voice mail (IVM) system 100 of FIG. 1, according to an illustrative embodiment of the present invention.

The method includes a start block 202 that passes control to a function block 204. The function block 204 receives an incoming call to the IVM system 100 from an end-user (hereinafter “caller”) who has dialed a pre-specified telephone number. It is preferable, but not mandatory, that the pre-specified telephone number is a local number or a toll-free number. The function block 204 passes control to a function block 206. The function block 206 plays a prompt welcoming the caller to the inmate voice mail system, and passes control to a function block 208. The function block 208 plays a prompt requesting the caller to enter the mailbox identification number for a particular inmate, and passes control to an input block 210. The input block 210 receives the mailbox ID number (hereinafter “ID#”)) for the particular inmate, and passes control to a decision block 212. The decision block 212 determines whether or not the mailbox ID# entered by the caller exists in the IVM database (DB). If the mailbox ID# entered by the caller does not exist in the IVM database, then control is passed to decision block 214. Otherwise, if the mailbox ID# entered by the caller does exist in the IVM database, then control is passed to function block 224.

The decision block 214 queries the ICP pin_record table (hereinafter “ICP database”) to determine whether or not the mailbox ID# entered by the caller exists in the ICP database. If the mailbox ID# entered by the caller does not exist in the ICP database, then control is passed to a function block 216. Otherwise, if the mailbox ID# entered by the caller does exist in the ICP database, then control is passed to a function block 242.

The function block 216 plays a prompt stating “that mailbox does not exist”, and passes control to a decision block 218. The decision block 218 determines whether or not the current mailbox ID# (input at input block 210) corresponds to a third attempt to input a recognized mailbox ID number. If the current mailbox ID# does not correspond to the third attempt, then control is returned to input block 210. Otherwise, if the current mailbox ID# does correspond to the third attempt, then control is passed to function block 220.

The function block 220 plays a prompt stating “thank you for calling, goodbye”, as passes control to an end block 222. The end block 222 terminates the call.

The function block 224 queries the active_messages table to determine whether or not the record count is equal to the maximum number of messages (Max_messages). If the record count is not equal to the maximum number of messages, then control is passed to a function block 226. Otherwise, if the record count is equal to the maximum number of messages, then control is passed to a function block 238.

The function block 226 plays a prompt describing recording instructions for recording a voicemail on the IVM system 100, and passes control to a function block 228. The function block 228 records the message left by the caller, and passes control to a function block 230. The function block 230 plays a prompt describing recording options for the message recorded at function block 228. The recording options include listening to the message recorded at function block 228 (option 1), re-recording the message recorded at function block 228 (option 2), and saving the message recorded at function block 228 (option 3). The function block 230 then passes control to a decision block 232. The decision block 232 determines which option was selected from among the described options (options 1-3). If option 1 was selected, then control is passed to a function block 234. Otherwise, if option 2 was selected, then control is returned to function block 226. Otherwise, if option 3 was selected, then control is passed to a function block 236.

The function block 242 creates a mailbox in the IVM system 100, and passes control-to function block 224.

The function block 238 plays a prompt stating “that mailbox is full, please try your call again later”, and passes control to end block 222.

The function block 236 saves the message, and passes control to a function block 240. The function block 240 plays a prompt stating “your message has been saved”, as passes control to function block 220.

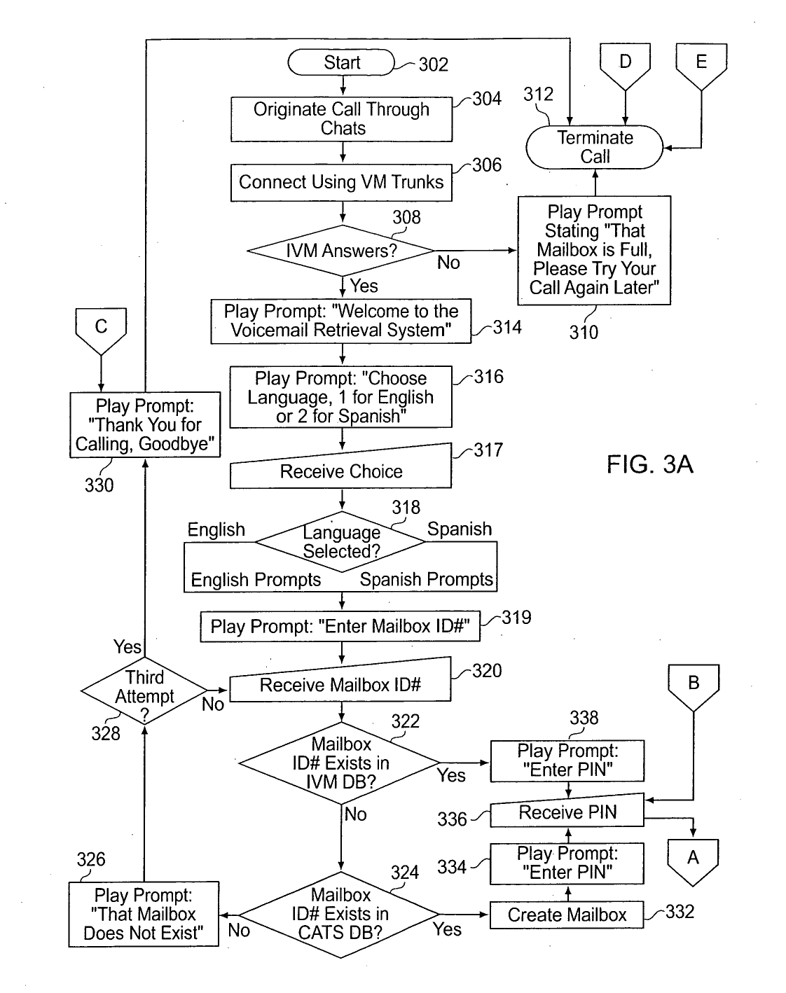

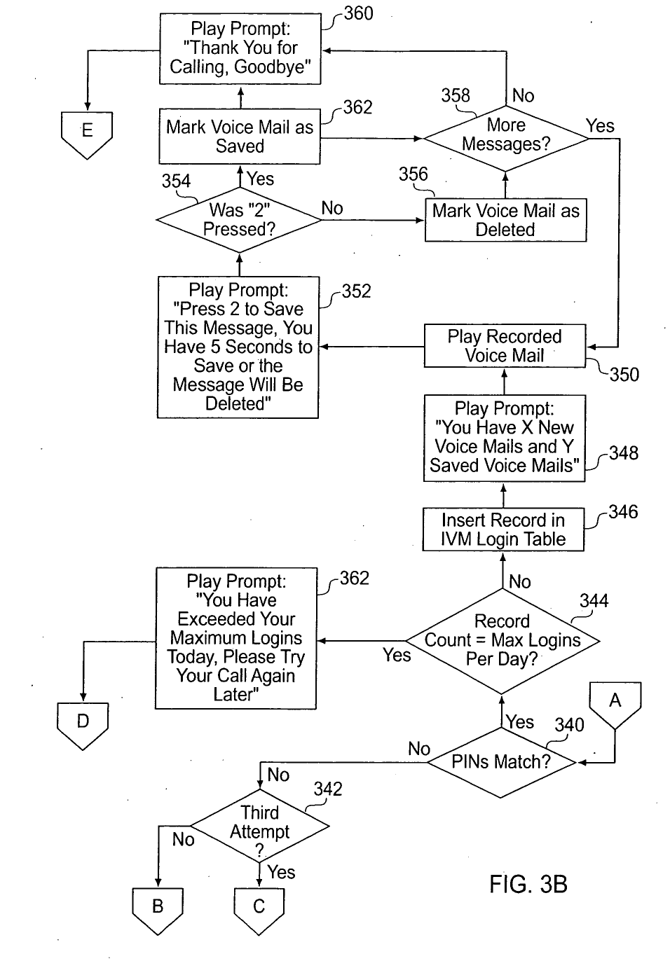

FIG. 3 is a flow diagram illustrating a method 300-for retrieving a voice mail from the inmate voice mail (IVM) system 100 of FIG. 1, according to an illustrative embodiment of the present invention.

The method includes a start block 302 that passes control to a function block 304. The function block 304 originates a call to the IVM system 100 through ICP to retrieve a voice mail, and passes control to a function block 306. The function block 306 connects the call originated by function block 304 using dedicated voice mail (VM) trunks, and passes control to a decision block 308. The decision block 308 determines whether or not the IVM system 100 has answered the call. If the IVM system 100 has not answered the call, then control is passed to a function block 310. Otherwise, if the IVM system 100 has answered the call, the control is passed to a function block 314.

The function block 310 plays a prompt stating “your party is not answering, please try your call again later”, and passes control to an end block 312. The end block 312 terminates the call.

The function block 314 plays a prompt stating “welcome to the voice mail retrieval system”, and passes control to a function block 316. The function block 316 plays a prompt stating “choose language, 1 for English or 2 for Spanish”, and passes control to an input block 317. The input block 317 receives the language choice (English or Spanish) entered by the user (inmate), and passes control to a decision block 318. The decision block 318 determines which language, English or Spanish, was chosen by the user (inmate). If English was chosen, then control passes to function block 319 with subsequent prompts provided to the user in English. Otherwise, if Spanish was chosen, then control passes to function block 319 with subsequent prompts provided to the user in Spanish.

The function block 319 plays a prompt stating “enter mailbox ID#”, and passes control to an input block 320. The input block 320 receives the mailbox ID#, and passes control to a decision block 322. The decision block 322 determines whether or not the mailbox ID# exists in the IVM data database (DB). If the mailbox ID# does not exist in the IVM database, then control is passed to decision block 324. Otherwise, if the mailbox ID# does exist in the IVM database, then control is passed to function block 338.

The decision block 324 queries the ICP pin_record table (hereinafter “ICP database”) to determine whether or not the mailbox ID# exists in the ICP database. If the mailbox ID# does not exist in the ICP database, then control is passed to a function block 326. Otherwise, if the mailbox ID# does exist in the ICP database, then control is passed to a function block 332.

The function block 326 plays a prompt stating “that mailbox does not exist”, and passes control to a decision block 328. The decision block 328 determines whether or not the current mailbox ID# (input at input block 320) corresponds to a third attempt to input a recognized mailbox ID number. If the current mailbox ID# does not correspond to the third attempt, then control is returned to input block 320. Otherwise, if the current mailbox ID# does correspond to the third attempt, then control is passed to function block 330.

The function block 330 plays a prompt stating “thank you for calling, goodbye”, as passes control to end block 312. The end block 312 terminates the call.

The function block 338 plays a prompt stating “enter PIN”, and passes control to an input block 336. The input block 336 receives the PIN entered by the user, and passes control to a decision block 340. The decision block 340 queries the ICP pin_record table (hereinafter “ICP database”) to determine whether or not the PIN entered by the user matches any PINs in the ICP database. If the PINs do not match, then control is passed to a decision block 342. Otherwise, if the PINs match, then control is passed to a decision block 344.

The decision block 342 determines whether or not the current mailbox ID# (input at input block 210) corresponds to a third attempt to input a recognized mailbox ID number. If the current mailbox ID# does not correspond to the third attempt, then control is returned to input block 336. Otherwise, if the current mailbox ID# does correspond to the third attempt, then control is passed to function block 330.

The function block 332 creates a mailbox in the IVM system 100, and passes control to a function block 334. The function block 334 plays a prompt stating “enter PIN”, and passes control to input block 336.

The decision block 344 queries an IVM logins table to determine whether or not the (current) record count is equal to the maximum (MAX) number of logins allowed per day. If the record count is not equal to the maximum number of logins allowed per day, then control is passed to a function block 346. Otherwise, if the record count is equal to the maximum number of logins allowed per day, then control is passed to a function block 362.

The function block 346 inserts the (current) record in the IVM login table, and passes control to a function block 348. The function block 348 plays a prompt stating “you have X new voice mails and Y saved voice mails”, and passes control to a function block 350. The function block 350 plays the recorded voice mail, and passes control to a function block 352. The function block 352 plays a prompt stating “press 2 to save this message, you have 5 seconds to save or the message will be deleted”, and passes control to a decision block 354. The decision block 354 determines whether or not “2” was pressed. If “2” was not pressed, then control passes to a function block 356. Otherwise, if “2” was pressed, then control passes to a function block 362.

The function block 356 marks the voice mail as deleted, and passes control to a decision block 358. The decision block 358 determines whether or not there are any more messages. If there are not any more messages, then control is passed to a function block 360. Otherwise, if there are any more messages, then control returns to function block 350.

The function block 360 plays a prompt stating “thank you for calling, goodbye”, as passes control to end block 312.

The function block 362 plays a prompt stating “you have exceeded your maximum logins today, please try your call again later”, and passes control to end block 312.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A method for leaving a voice mail for an inmate in a correctional facility from an external caller outside the prison facility, comprising the steps of:
receiving identifying indicia for identifying the inmate from among a plurality of inmates;
comparing the identifying indicia against a plurality of identifying indicia to determine whether a match exists there between, each of the plurality of identifying indicia for identifying one of the plurality of inmates; and
permitting the external caller to leave the voice mail for the inmate, only when the match exists.

2. The method of claim 1, further comprising the step of restricting the external caller from retrieving any voice mails left for other inmates of the correctional facility.

3. The method of claim 1, further comprising the step of restricting the external caller from leaving the voice mail for the inmate, when the match does not exists.

4. The method of claim 1, further comprising the step of restricting the inmate from leaving a voice mail for any other inmate of the correctional facility.

5. The method of claim 1, wherein the identifying indicia comprises a mailbox identification number.

6. The method of claim 1, wherein the plurality of identifying indicia comprises a plurality of mailbox identification numbers, and the method further comprises the steps of:
comparing the identifying indicia against each of a plurality of other identifying indicia to determine whether a correspondence exists there between; and
creating a new mailbox for the inmate, when the identifying indicia does not match any of the plurality of identifying indicia but does match one of the plurality of other identifying indicia.

7. The method of claim 1, further comprising the step of repeating said comparing step until one of, whichever occurs first, the match is determined and said comparing step has already been repeated a pre-specified maximum number of times permitted during a single call.

8. The method of claim 1, further comprising the step of restricting a time duration of the voice mail.

9. The method of claim 1, further comprising the step of restricting a number of voice mails that are capable of being left for the inmate.

10. The method of claim 9, wherein said restricting step restricts the number of voice mails that are capable of being left for the inmate in a pre-specified time period.

11. The method of claim 1, wherein said permitting step comprises the step of converting the voice mail into a compressed audio format

12. The method of claim 1, further comprising the steps of:
prompting the external caller to select a language;
receiving a language selection from the external caller; and
providing any subsequent prompts to the external caller according to the language selection received from the external caller.

13. A program storage device readable by machine, tangibly embodying a program of instructions executable by the machine to perform method steps for leaving the voice mail for the inmate in the correctional facility from the external caller outside the prison facility as recited in claim 1.

14. A method for retrieving a voice mail by an inmate in a correctional facility, the voice mail left by an external caller located outside the correctional facility, the method comprising the steps of:
receiving verification indicia for verifying a claimed identity of the inmate;
comparing the verification indicia against each of a plurality of verification indicia to determine whether a match exists there between; and
permitting the inmate to retrieve the voice mail, only when the match exists.

15. The method of claim 14, wherein the verification indicia comprises a personal identification number.

16. The method of claim 14, further comprising the steps of:
receiving identifying indicia from the inmate for establishing the claimed identity; and
comparing the identifying indicia against a plurality of identifying indicia, each of the plurality of identifying indicia for identifying one of a plurality of inmates of the correctional facility; and
performing said receiving step, only if the verification indicia matches one of the plurality of verification indicia.

17. The method of claim 16, wherein the identifying indicia comprises a mailbox identification number.

18. The method of claim 14, further comprising the step of restricting the inmate to at least one of only playing back and saving the voice mail, when the voice mail is permitted to be retrieved.

19. The method of claim 14, further comprising the step of restricting the inmate from the deleting the voice mail, when the voice mail is permitted to be retrieved.

20. The method of claim 14, further comprising the steps of:
maintaining a record of a number of login attempts performed by the inmate in a pre-specified time period;
comparing the number of login attempts performed by the inmate in the pre-specified time period to a pre-specified maximum number of login attempts permitted during the pre-specified time period; and
restricting access to the voice mail, when the number of login attempts performed by the inmate is greater than the pre-specified maximum number of login attempts permitted during the pre-specified time period.

21. The method of claim 14, further comprising the steps of:
granting the inmate limited access to the voice mail; and
providing a pre-specified and configurable set of individuals other than the inmate with unrestricted access to the voice mail, and wherein the inmate is barred from inclusion into the set of pre-specified and configurable individuals.

22. The method of claim 14, further comprising the steps of:
granting the inmate limited control of the voice mail; and
providing a pre-specified and configurable set of individuals other than the inmate with unrestricted control of the voice mail, and wherein the inmate is barred from inclusion into the set of pre-specified and configurable individuals.

23. The method of claim 14, further comprising the steps of:
prompting the inmate to select a language;
receiving a language selection from the external caller; and
providing any subsequent prompts to the inmate according to the language selection received from the inmate.

24. The method of claim 14, wherein the voice mail is stored in a compressed format, and said permitting step comprises the step of uncompressing the voice mail.

25. A program storage device readable by machine, tangibly embodying a program of instructions executable by the machine to perform method steps for retrieving the voice mail by the inmate in the correctional facility as recited in claim 1.

26. A system for leaving a voice mail for an inmate in a correctional facility from an external caller outside the prison facility, comprising:
means for receiving identifying indicia for identifying the inmate from among a plurality of inmates;
means for comparing the identifying indicia against a plurality of identifying indicia to determine whether a match exists there between, each of the plurality of identifying indicia for identifying one of the plurality of inmates; and
means for permitting the external caller to leave the voice mail for the inmate, only when the match-exists.

27. The system of claim 26, further comprising means for restricting the external caller from retrieving any voice mails left for other inmates of the correctional facility.

28. The system of claim 26, further comprising means for restricting the external caller from leaving the voice mail for the inmate, when the match does not exists.

29. The system of claim 26, further comprising means for restricting the inmate from leaving a voice mail for any other inmate of the correctional facility.

30. The system of claim 26, wherein the identifying indicia comprises a mailbox identification number.

31. The system of claim 26, wherein the plurality of identifying indicia comprises a plurality of mailbox identification numbers, and the system further comprises:
means for comparing the identifying indicia against each of a plurality of other identifying indicia to determine whether a correspondence exists there between; and
means for creating a new mailbox for the inmate, when the identifying indicia does not match any of the plurality of identifying indicia but does match one of the plurality of other identifying indicia.

32. The system of claim 26, wherein said means for comparing repeatedly compares the identifying indicia against each of the plurality of other identifying indicia until one of, whichever occurs first, the match is determined and said means for comparing has performed a comparison a pre-specified maximum number of times permitted during a single call.

33. The system of claim 26, further comprising means for restricting a time duration of the voice mail.

34. The system of claim 26, further comprising means for restricting a number of voice mails that are capable of being left for the inmate.

35. The system of claim 34, wherein said means for restricting restricts the number of voice mails that are capable of being left for the inmate in a pre-specified time period.

36. The system of claim 26, wherein said means for permitting comprises means for converting the voice mail into a compressed audio format

37. The system of claim 26, further comprising:
means for prompting the external caller to select a language;
means for receiving a language selection from the external caller; and
means for providing any subsequent prompts to the external caller according to the language selection received from the external caller.

38. The system of claim 26, wherein the system is disposed locally with respect to the correctional facility.

39. The system of claim 26, wherein the system is utilized for at least two correctional facilities.

40. A system for retrieving a voice mail by an inmate in a correctional facility, the voice mail left by an external caller located outside the correctional facility, the system comprising:
means for receiving verification indicia for verifying a claimed identity of the inmate;
means for comparing the verification indicia against each of a plurality of verification indicia to determine whether a match exists there between; and
means for permitting the inmate to retrieve the voice mail, only when the match exists.

41. The system of claim 40, wherein the verification indicia comprises a personal identification number.

42. The system of claim 40, further comprising:
means for receiving identifying indicia from the inmate for establishing the claimed identity; and
means for comparing the identifying indicia against a plurality of identifying indicia, each of the plurality of identifying indicia for identifying one of a plurality of inmates of the correctional facility; and
wherein said means for receiving the identifying indicia is employed only if the verification indicia matches one of the plurality of verification indicia.

43. The system of claim 42, wherein the identifying indicia comprises a mailbox identification number.

44. The system of claim 40, further comprising means for restricting the inmate to at least one of only playing back and saving the voice mail, when the voice mail is permitted to be retrieved.

45. The system of claim 40, further comprising means for restricting the inmate from the deleting the voice mail, when the voice mail is permitted to be retrieved.

46. The system of claim 40, further comprising:
means for maintaining a record of a number of login attempts performed by the inmate in a pre-specified time period;
means for comparing the number of login attempts performed by the inmate in the pre-specified time period to a pre-specified maximum number of login attempts permitted during the pre-specified time period; and
means for restricting access to the voice mail, when the number of login attempts performed by the inmate is greater than the pre-specified maximum number of login attempts permitted during the pre-specified time period.

47. The system of claim 40, further comprising:
means for granting the inmate limited access to the voice mail; and
means for providing a pre-specified and configurable set of individuals other than the inmate with unrestricted access to the voice mail, and wherein the inmate is barred from inclusion into the set of pre-specified and configurable individuals.

48. The system of claim 40, further comprising:
means for granting the inmate limited control of the voice mail; and
means for providing a pre-specified and configurable set of individuals other than the inmate with unrestricted control of the voice mail, and wherein the inmate is barred from inclusion into the set of pre-specified and configurable individuals.

49. The system of claim 40, further comprising:
means for prompting the inmate to select a language;
means for receiving a language selection from the external caller; and
means for providing any subsequent prompts to the inmate according to the language selection received from the inmate.

50. The system of claim 40, wherein the voice mail is stored in a compressed format, and said means for permitting comprises means for uncompressing the voice mail.

51. The system of claim 40, wherein the system is disposed locally with respect to the correctional facility.

52. The system of claim 40, wherein the system is utilized for at least two correctional facilities.
